(19) United States
(12) Patent Application Publication
(10) Pub. No.: US 2020/0198275 A1
(43) Pub. Date: Jun. 25, 2020

(54) APPARATUS FOR MANUFACTURING GREEN TIRE AND METHOD FOR MANUFACTURING GREEN TIRE

(71) Applicant: Toyo Tire Corporation, Itami-shi (JP)

(72) Inventor: Hiroaki MORINO, Itami-shi (JP)

(73) Assignee: Toyo Tire Corporation, Itami-shi (JP)

(21) Appl. No.: 16/702,955

(22) Filed: Dec. 4, 2019

(30) Foreign Application Priority Data
Dec. 19, 2018 (JP) 2018-237517

(51) Int. Cl. B29D 30/28; B29D 30/30

(52) U.S. Cl. CPC B29D 30/28; B29D 30/3007

(57) ABSTRACT

In an apparatus for manufacturing a green tire in which after a supply part 30 supplies a tip portion 3a of a rubber member 3 to a molding drum 10 in a stationary state, the molding drum 10 rotates to wind the rubber member 3 onto the molding drum 10 and to thereby manufacture a green tire, a pressing member 52 configured to press the rubber member 3 to the molding drum 10 presses the tip portion 3a of the rubber member 3 supplied to the molding drum 10 to the molding drum 10 in the stationary state, and moves in a tangential direction of the molding drum 10 and separates from the rubber member 3 after rotation of the molding drum 10 starts.

### TECHNICAL FIELD

The present invention relates to an apparatus for manufacturing a green tire and a method for manufacturing a green tire.

### BACKGROUND ART

A green tire before vulcanization is manufactured by sequentially winding a rubber member configured by band-shaped unvulcanized rubber, such as an inner liner, a sidewall rubber and a carcass ply, onto an outer peripheral surface of a molding drum being rotated. The winding of the rubber member is performed as a result of the winding of the member due to the rotation of the drum, and after completion, the rubber member is removed from the drum and is sent to a next process. For this reason, a surface of the molding drum is subjected to a surface treatment so as to cause the surface to have appropriate adhesiveness for clean winding of the member and appropriate mold release performance for clean unwinding of the member.

When winding the rubber member, tensile force is applied to the rubber member. Adhesive force between the rubber and the drum surface against the tensile force cannot be made so great as described above. For this reason, when the adhesive force between the rubber member and the molding drum is insufficient, the rubber member may cause slippage position displacement on the outer peripheral surface of the molding drum. Therefore, a device having a mechanism configured to prevent the position displacement is suggested (for example, refer to JP-A-2006-289704 and JP-A-2012-40797).

JP-A-2006-289704 discloses a device configured to rotate a molding drum while holding a tip portion of a rubber member with a fixed member attached to the molding drum.

JP-A-2012-40797 discloses a device configured to press the tip portion of the rubber member supplied to the molding drum by a pressing member, and to rotate the molding drum by one revolution in this state, thereby winding the rubber member on the molding drum. When winding of an unvulcanized tread is over, the pressing member is moved to a position spaced from the molding drum by a moving means.

### SUMMARY OF THE INVENTION

However, in the device of JP-A-2006-289704, the configuration of the molding drum is complicated, and a manufacturing apparatus including the molding drum may be enlarged.

Also, according to JP-A-2012-40797, after rotating the pressing member around the molding drum by one revolution, in conformity to the rotation of the molding drum, the pressing member should be moved from a circumferential surface of the molding drum by the moving means. As a result, the structures of the pressing member and the moving means are complicated.

Further, according to JP-A-2012-40797, since the moving means moves the pressing member outward in a radial direction of the molding drum, the large force is applied to the rubber member in a direction away from the molding drum during the movement of the pressing member, so that the rubber member may be peeled off from the molding drum or may be deformed.

The present invention has been made in view of the above situations, and is to provide an apparatus for manufacturing a green tire and a method for manufacturing a green tire capable of securely holding and winding a rubber member on a molding drum while suppressing a structure of the manufacturing apparatus from being complicated.

An apparatus for manufacturing a green tire in accordance with the present invention is an apparatus for manufacturing a green tire including a molding drum, and a supply part configured to supply a rubber member to the molding drum, in which after the supply part supplies a tip portion of the rubber member to the molding drum in a stationary state, the molding drum rotates to wind the rubber member on the molding drum and to thereby manufacture a green tire. The manufacturing apparatus includes a pressing member configured to press the rubber member to the molding drum. The pressing member is configured to press the tip portion of the rubber member supplied to the molding drum to the molding drum in the stationary state, and to move in a tangential direction of the molding drum and to separate from the rubber member after rotation of the molding drum starts.

A method for manufacturing a green tire in accordance with the present invention is a method for manufacturing a green tire in which a molding drum and a supply part configured to supply a rubber member to the molding drum are provided and after the supply part supplies a tip portion of the rubber member to the molding drum in a stationary state, the molding drum rotates to wind the rubber member on the molding drum and to thereby manufacture a green tire. The manufacturing method includes a process of the pressing member pressing the tip portion of the rubber member supplied to the molding drum to the molding drum in the stationary state, and a process of moving the pressing member in a tangential direction of the molding drum and separating the same from the rubber member after rotation of the molding drum starts.

According to the present invention, it is possible to securely hold and wind the rubber member on the molding drum while suppressing a structure of the manufacturing apparatus from being complicated.

### BRIEF DESCRIPTION OF THE DRAWINGS

FIG. 1 is a schematic side view of an apparatus for manufacturing a green tire in accordance with an exemplary embodiment of the present invention.

FIG. 2 is a sectional view taken along a line A-A of FIG. 1.

FIG. 3 is a schematic side view depicting a state in which a conveying device supplies a sidewall rubber to a molding drum in the manufacturing apparatus of FIG. 1.

FIG. 4 is a schematic side view depicting a state in which a pressing member presses the sidewall rubber in the manufacturing apparatus of FIG. 1.

FIG. 5 is a schematic side view depicting a state immediately after the molding drum has started to rotate in the manufacturing apparatus of FIG. 1.

FIG. 6 is a schematic side view depicting a state in which the sidewall rubber is wound on the molding drum in the manufacturing apparatus of FIG. 1.

FIG. 7 is a schematic side view depicting a state in which the sidewall rubber is cut in the manufacturing apparatus of FIG. 1.

FIG. 8 is a schematic side view depicting an operation of an apparatus for manufacturing a green tire in accordance with a modified embodiment of the present invention.

FIG. 9 is a schematic side view depicting an operation of an apparatus for manufacturing a green tire in accordance with another modified embodiment of the present invention.

### DETAILED DESCRIPTION OF THE INVENTION

Hereinbelow, an exemplary embodiment of the present invention will be described with reference to the drawings.

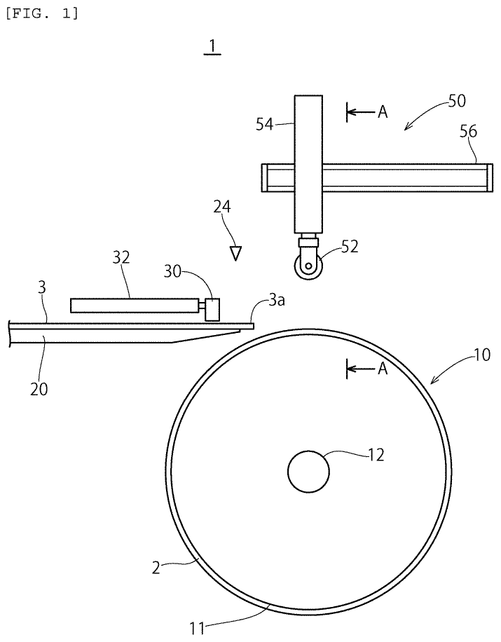

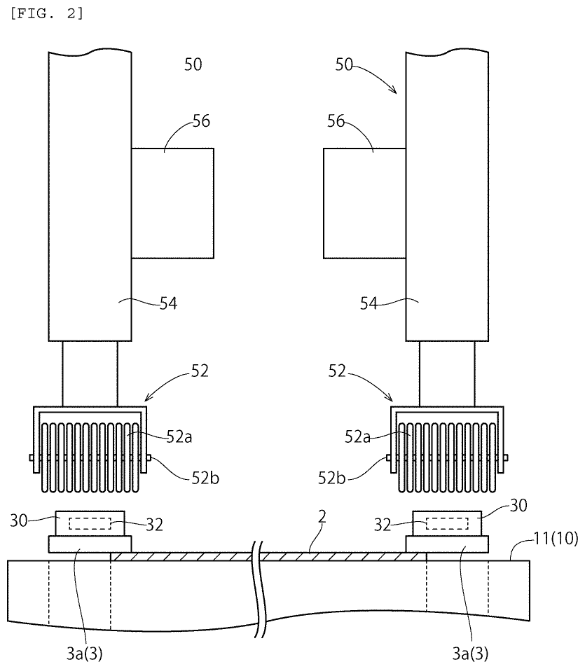

As shown in FIGS. 1 and 2, an apparatus for manufacturing a green tire of the exemplary embodiment (hereinbelow, also referred to as ‘manufacturing apparatus’) 1 includes a molding drum 10, supply tables 20, conveying devices 30 and pressing mechanisms 50.

The manufacturing apparatus 1 is an apparatus configured to bond a band-shaped sidewall rubber 3 placed on the supply table 20 to each of both sides in a width direction of an outer surface of an inner liner 2 provided on an outer peripheral surface of the molding drum 10. More specifically, the sidewall rubber 3 is wound on the molding drum 10 so that an inner side of the sidewall rubber 3 in the width direction is to overlap a side of the inner liner 2 in the width direction and an outer side of the sidewall rubber 3 in the width direction is to overlap an outer peripheral surface of the molding drum 10. That is, the sidewall rubber 3 is wound on the molding drum 10 so that a part of the sidewall rubber 3 is to overlap the inner liner 2 wound on the molding drum 10 in an axial direction of the molding drum 10.

Meanwhile, since the manufacturing apparatus 1 is configured to bond the sidewall rubber 3 to both sides of the inner liner 2 in the width direction, as shown in FIG. 2, the supply table 20, the conveying device 30 and the pressing mechanism 50 are respectively provided by a pair at left and right sides, respectively. However, the supply tables 20, the conveying devices 30 and the pressing mechanisms 50 at the left and right sides have the same configuration, and perform the same operations, respectively.

The molding drum 10 includes a cylindrical drum part 11 on which the sidewall rubber 3 is to be wound and bonded, and a rotary shaft 12 configured to rotatably support the drum part 11. The molding drum 10 includes a servo motor (not shown) as a drive source, and can adjust a rotating angle when bonding the sidewall rubber 3. An outer peripheral surface of the drum part 11 of the molding drum 10 is provided thereon with the inner liner 2 in advance by a separate process.

The supply table 20 is arranged so that one end (tip) is spaced from the drum part 11 by a predetermined interval with facing the outer peripheral surface of the drum part 11 of the molding drum 10, and the sidewall rubber 3 is placed on an upper surface thereof. A front end portion of the supply table 20 is provided with a cutting device 24 for cutting the sidewall rubber 3 on the supply table 20 into a predetermined size.

The conveying device 30 is provided over a tip portion of the supply table 20 and the molding drum 10, and is configured to be movable between the tip portion of the supply table 20 and the molding drum 10 by a moving means 32 attached to a frame or the like (not shown).

The conveying device 30 includes a suction means for sucking an upper surface of the sidewall rubber 3 placed on the supply table 20 by vacuum suction or the like. The conveying device 30 is configured to hold a tip portion 3a of the sidewall rubber 3 placed on the supply table 20 and to supply the same to an outer surface of the inner liner 2 provided on the outer peripheral surface of the drum part 11 of the molding drum 10. That is, the conveying device 30 configures a supply part configured to supply the sidewall rubber 3 to the molding drum 10.

The pressing mechanism 50 includes a pressing member 52 configured to press and bond the tip portion 3a of the sidewall rubber 3 supplied to the molding drum 10 onto the outer peripheral surface of the drum part 11, and a first drive part 54 and a second drive part 56 configured to move the pressing member 52.

Also, the pressing member 52 is configured by a washer roller of which a plurality of disc-shaped washers 52a are coupled at centers thereof by a rotary shaft 52b, for example. When pressing the sidewall rubber 3 to the drum part 11 of the molding drum 10, since a position of each washer 52a is changed in conformity to an unevenness shape generated on the outer peripheral surface of the drum part 11 by the inner liner 2 and the sidewall rubber 3, the pressing member 52 can press the sidewall rubber 3 to the drum part 11 in the width direction with uniform force.

The first drive part 54 consists of an air cylinder, for example, and is configured to move the pressing member 52 in a radial direction (vertical direction, in the drawings) of the drum part 11. The second drive part 56 consists of an air cylinder, for example, and is configured to move the pressing member 52 provided to the first drive part 54 in a direction (a left and right direction, in FIG. 1) in which the conveying device 30 conveys the sidewall rubber 3 from the supply table 20 to the molding drum 10.

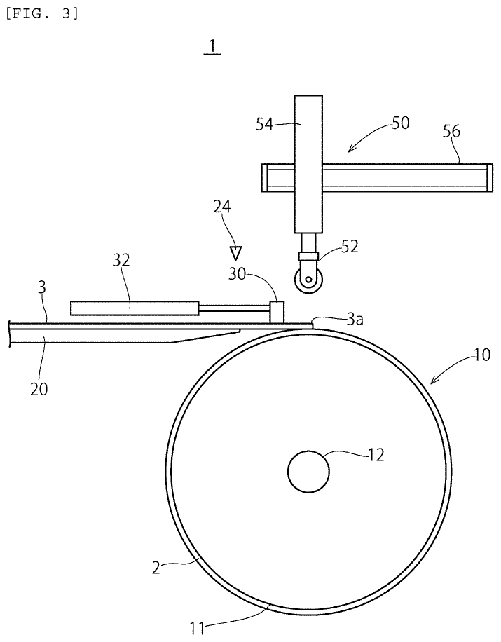

Subsequently, a method for manufacturing a green tire in accordance with an exemplary embodiment in which the manufacturing apparatus 1 is used is described with reference to FIGS. 3 to 6.

First, as shown in FIG. 3, the conveying device 30 sucks the tip portion 3a of the sidewall rubber 3 placed on the supply table 20. Then, the conveying device 30 moves to a predetermined position (hereinbelow, also referred to as ‘supply position P’) above the drum part 11 of the molding drum 10, and supplies the tip portion 3a of the sidewall rubber 3 to the drum part 11. Herein, the tip portion 3a of the sidewall rubber 3 is supplied to a predetermined position on the outer peripheral surface of the drum part 11 so that an inner side of the tip portion 3a of the sidewall rubber 3 in the width direction is to overlap a side of the inner liner 2 in the width direction and an outer side of the tip portion 3a of the sidewall rubber 3 in the width direction is to overlap the outer peripheral surface of the molding drum 10.

In the meantime, while the conveying device 30 supplies the tip portion 3a of the sidewall rubber 3 to the drum part 11, the pressing member 52 is arranged above the supply position P.

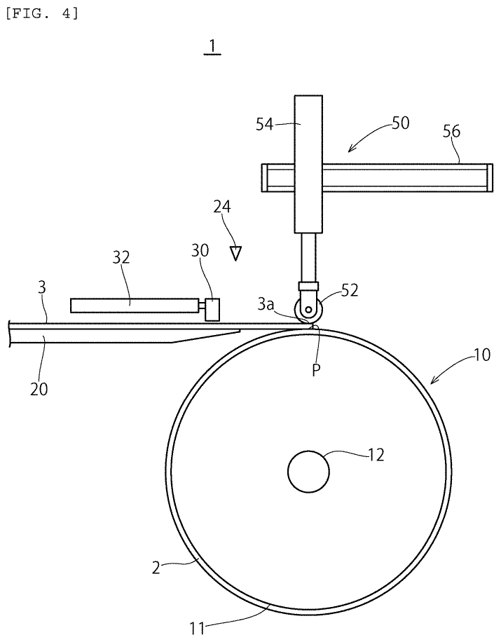

Then, when the tip portion 3a of the sidewall rubber 3 is supplied to the drum part 11, the conveying device 30 separates from the drum part 11, as shown in FIG. 4. Also, the first drive part 54 moves the pressing member 52 downward, thereby pressing the tip portion 3a of the sidewall rubber 3 to the outer peripheral surface of the drum part 11 by the pressing member 52. At this time, the drum part 11 is in a stationary state.

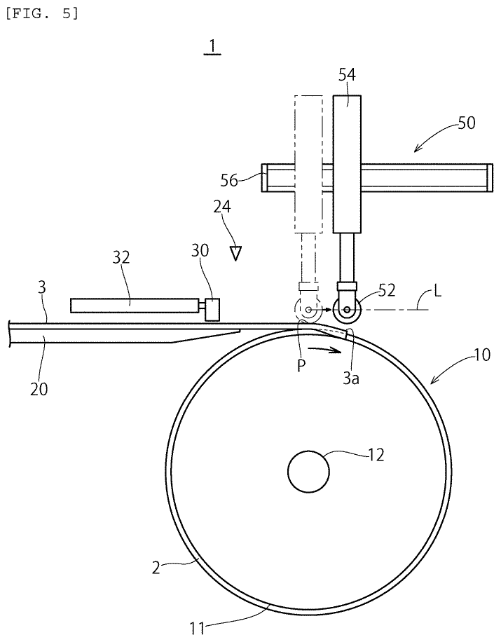

Then, when the pressing member 52 presses the tip portion 3a of the sidewall rubber 3 to the drum part 11, the servo motor is activated to rotate the drum part 11, as shown in FIG. 5. Upon the start of rotation of the drum part 11, the second drive part 56 moves the pressing member 52 from the supply position P of the drum part 11 forward with respect to the moving direction of the sidewall rubber 3 (forward in a direction in which the conveying device 30 conveys the sidewall rubber 3 from the supply table 20 toward the molding drum 10), and in a tangential direction L of the drum part 11, thereby separating the pressing member 52 from the sidewall rubber 3.

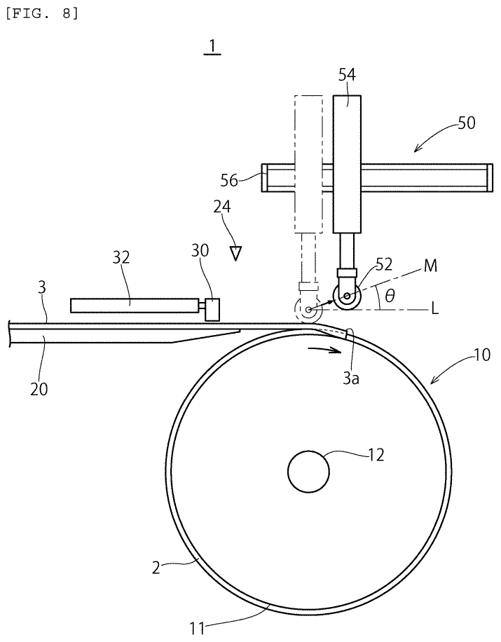

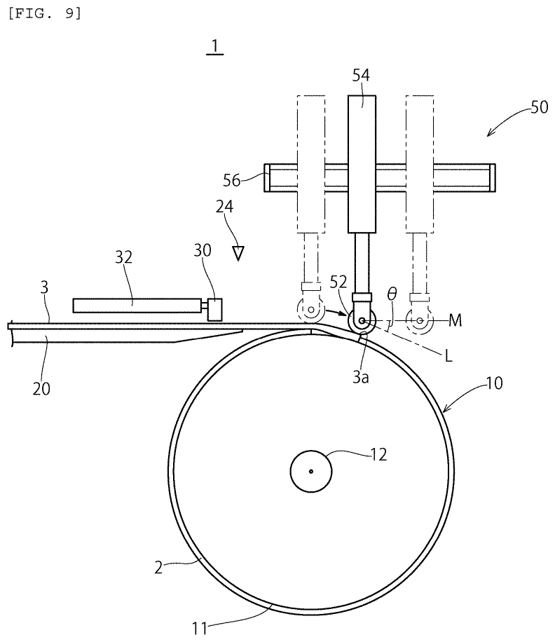

In the specification, the tangential direction is a concept including a direction that completely coincides with the tangential direction L of the drum part 11 and a direction inclined within 45° in a direction away from the drum part 11 relative to the direction L that completely coincides with the tangential direction of the drum part 11. That is, as shown in FIGS. 8 and 9, an angle θ of a direction M, in which the pressing member 52 is to be moved upon the start of rotation of the drum part 11, relative to the direction L that completely coincides with the tangential direction of the drum part 11 is preferably within 45°.

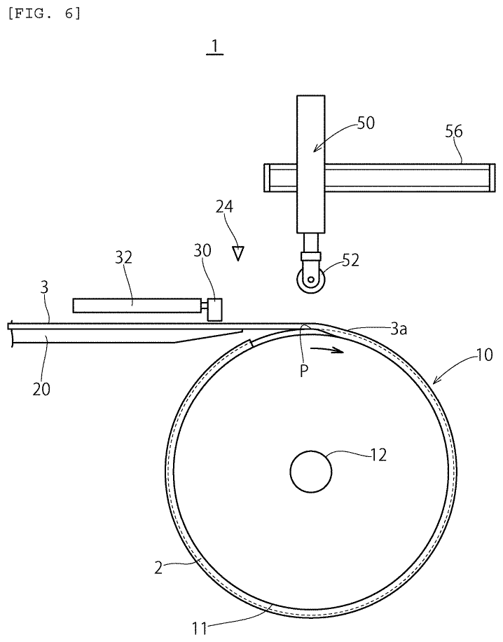

Even after the pressing member 52 separates from the sidewall rubber 3, the drum part 11 is continuously rotated to wind the sidewall rubber 3 placed on the supply table 20 onto the drum part 11 (refer to FIG. 6). In the meantime, while winding the sidewall rubber 3 onto the drum part 11 by the rotation of the drum part 11, the pressing mechanism 50 moves the pressing member 52 to a position above the supply position P.

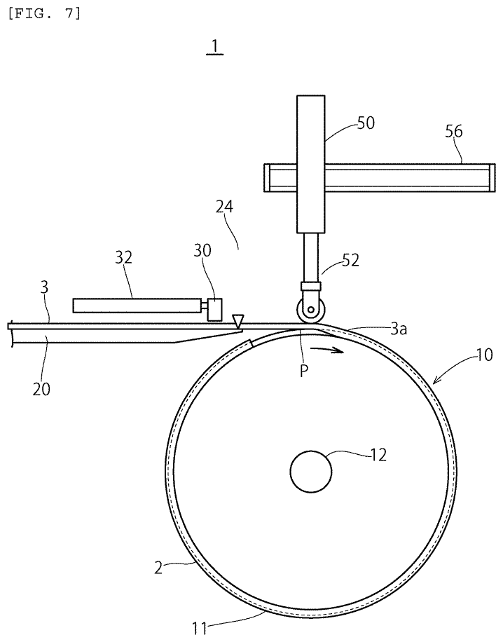

Then, the servo motor provided to the molding drum 10 stops at a point in time at which the drum part 11 is rotated by a predetermined angle after starting the rotation, so that the supply of the sidewall rubber 3 to the drum part 11 is temporarily stopped. Thereafter, the first drive part 54 moves downward the pressing member 52, thereby pressing the tip portion 3a of the sidewall rubber 3 to the outer peripheral surface of the drum part 11 by the pressing member 52. Then, in the state in which the pressing member 52 presses the sidewall rubber 3, the sidewall rubber 3 is cut by the cutting device 24, so that a rear end portion 3b of the sidewall rubber 3 is formed (refer to FIG. 7).

When the cutting on the sidewall rubber 3 is completed, the servo motor is again activated to rotate the drum part 11, thereby winding the rear end portion 3b of the sidewall rubber 3 onto the drum part 11 and bonding the same onto the outer surface of the inner liner 2 so as to overlap the tip portion 3a of the sidewall rubber 3 by a predetermined length. At this time, while the pressing member 52 presses the sidewall rubber 3 to the drum part 11, it winds the rear end portion 3b of the sidewall rubber 3 onto the drum part 11. Thereby, an overlapped portion of the tip portion 3a and the rear end portion 3b of the sidewall rubber 3 is bonded under pressure using the pressing member 52.

Then, the obtained member is assembled into a tire shape in accordance with a conventional method, together with the other tire members configuring a tire, such as a carcass, a belt, a bead core, a bead filler, a tread rubber and the like, so that a green tire (unvulcanized tire) is obtained.

According to the exemplary embodiment as described above, after the pressing member 52 presses the tip portion 3a of the sidewall rubber 3 supplied to the drum part 11 to the drum part 11 in the stationary state and bonds the tip portion 3b under pressure to the drum part 11, the drum part 11 rotates and the pressing member 52 moves in the tangential direction L of the molding drum 10. Therefore, it is possible to suppress slippage position displacement of the rubber member on the outer peripheral surface of the molding drum. Herein, it is not necessary to set a large moving distance of the pressing member 52, and the pressing member 52 may be set to follow one eighth or less of one rotation of the molding drum 10 (which corresponds to a rotating angle 45° of the molding drum 10). That is, since appropriate adhesiveness is applied to a drum surface, when the sidewall rubber is wound in a state in which a position of the tip portion 3a on the drum part 11 is secured, it is possible to sufficiently resist the tensile force applied to the sidewall rubber 3. Therefore, an amount of the movement of the pressing member 52 (a circumferential length within which the pressing member 52 is caused to follow the rotation of the molding drum 10) may be finely adjusted as appropriate, depending on a material, a formation condition and the like of the rubber member.

In particular, like the exemplary embodiment, when winding the sidewall rubber 3 onto the molding drum 10 so that the inner side of the sidewall rubber 3 in the width direction is to overlap the side of the inner liner 2 in the width direction and the outer side of the sidewall rubber 3 in the width direction is to overlap the outer peripheral surface of the molding drum 10, the sidewall rubber 3 is more likely to cause the position displacement in a portion to be stacked on the molding drum 10, as compared to a portion to be stacked on the inner liner 2, so that wrinkles are likely to occur at the tip portion 3a of the sidewall rubber 3. In the exemplary embodiment, as described above, after the pressing member 52 presses the tip portion 3a of the sidewall rubber 3, the molding drum 10 starts to rotate. Therefore, it is possible to suppress the wrinkles from occurring at the portion to be stacked on the molding drum 10.

Also, the pressing member 52 presses the tip portion 3a of the sidewall rubber 3 supplied to the drum part 11 to the drum part 11 in the stationary state, moves in the tangential direction of the drum part 11 and separates from the sidewall rubber 3 after the rotation of the drum part 11 starts. For this reason, according to the manufacturing apparatus 1 of the exemplary embodiment, it is not necessary to rotate the pressing member around the drum part 11 by one revolution, so that the apparatus structure is not complicated and is not enlarged.

Further, since the pressing member 52 moves in the tangential direction of the drum part 11 and separates from the sidewall rubber 3 after the rotation of the drum part 11 starts, when spacing the pressing member 52 from the sidewall rubber 3, the force that is applied to the sidewall rubber 3 in a direction away from the outer peripheral surface of the drum part 11 is reduced, so that it is possible to suppress the sidewall rubber 3 from being peeled off from the drum part 11 and the sidewall rubber 3 from being deformed.

### Modified Embodiments

The exemplary embodiment is just exemplary and is not intended to limit the scope of the invention. The novel exemplary embodiment can be implemented in other various forms, and can be diversely omitted, replaced and changed without departing from the gist of the invention.

In the exemplary embodiment, after the pressing member 52 presses the tip portion 3a of the sidewall rubber 3 supplied to the drum part 11 to the drum part 11 in the stationary state, the pressing member 52 moves in the tangential direction of the drum part 11 upon the start of rotation of the drum part 11, and separates from the tip portion 3a of the sidewall rubber 3. However, the present invention is not limited thereto. For example, as shown in FIG. 9, after the pressing member 52 presses the tip portion 3a of the sidewall rubber 3 to the drum part 11 in the stationary state, the first drive part 54 and the second drive part 56 may move the pressing member 52 in cooperation with each other so as to maintain the state in which the pressing member 52 presses the tip portion 3a of the sidewall rubber 3, until the drum part 11 rotates by a predetermined angle, and then move the pressing member 52 in the tangential direction to separate the pressing member 52 from the sidewall rubber 3.

In this way, the pressing member 52 continues to press the tip portion 3a of the sidewall rubber 3 until the drum part 11 rotates by the predetermined angle, so that it is possible to improve the adhesiveness of the sidewall rubber 3 to the drum part 11.

Also, in the exemplary embodiment, the sidewall rubber 3 as the rubber member is wound onto the drum part 11 of the molding drum 10. However, for example, the present invention can also be applied to various types of rubber members such as an inner liner, a carcass ply, a tread rubber and the like.

Also, in the exemplary embodiment, the washer roller is used as the pressing member 52 configured to press the rubber member such as the sidewall rubber 3 to the drum part 11. However, the present invention is not limited thereto. For example, the pressing member 52 may be a cylindrical member configured not to rotate around on its axis, such as a roller, a cylindrical roller made of metal or resin such as a urethane roller, or a roller of which an outer peripheral surface can be deformed in conformity to an unevenness shape of a target to be pressed. When a variety of rollers such as a washer roller and a cylindrical roller are used as the pressing member 52, it is possible to press the tip portion 3a of the sidewall rubber 3 to the drum part 11 by the pressing member 52, and to use the pressing member 52 even in a case in which the rear end portion 3b of the sidewall rubber 3 is wound onto the drum part 11 while pressing the same to the drum part 11, so that the apparatus configuration is further simplified.

Also, in the exemplary embodiment, the pressing member 52 configured to press the tip portion 3a of the rubber member such as the sidewall rubber 3 or the like to the drum part 11 also presses the overlapped portion of the tip portion 3a and the rear end portion 3b of the sidewall rubber 3. However, the pressing member 52 configured to press the tip portion 3a of the sidewall rubber 3 to the drum part 11 and a pressing member configured to press the overlapped portion of the tip portion 3a and the rear end portion 3b of the sidewall rubber 3 may be separately provided.

What is claimed is:

1. An apparatus for manufacturing a green tire comprising:
a molding drum;
a supply part configured to supply a rubber member to the molding drum; and
a pressing member configured to press the rubber member, which is supplied from the supply part, to the molding drum,
wherein the pressing member is configured to be movable in a tangential direction of the molding drum.

2. The apparatus for manufacturing a green tire according to claim 1,
wherein after the supply part supplies a tip portion of the rubber member to the molding drum in a stationary state, the molding drum rotates to wind the rubber member onto the molding drum and to thereby manufacture a green tire, and wherein the pressing member is configured to press the tip portion of the rubber member supplied to the molding drum to the molding drum in the stationary state, and to move in the tangential direction of the molding drum and to separate from the rubber member after rotation of the molding drum starts.

3. The apparatus for manufacturing a green tire according to claim 1,
wherein the pressing member is configured to move in the tangential direction of the molding drum upon start of the rotation of the molding drum.

4. The apparatus for manufacturing a green tire according to claim 1,
wherein the pressing member is a roller.

5. The apparatus for manufacturing a green tire according to claim 4,
wherein the pressing member comprises a washer roller provided to be deformable in conformity to a surface shape of the rubber member.

6. A method for manufacturing a green tire in which a molding drum and a supply part configured to supply a rubber member to the molding drum are provided and after the supply part supplies a tip portion of the rubber member to the molding drum in a stationary state, the molding drum rotates to wind the rubber member onto the molding drum and to thereby manufacture a green tire, the method comprising:
a process of the pressing member pressing the tip portion of the rubber member supplied to the molding drum to the molding drum in the stationary state, and
a process of moving the pressing member in a tangential direction of the molding drum and separating the same from the rubber member after rotation of the molding drum starts.

7. The method for manufacturing a green tire according to claim 6,
wherein the pressing member is moved in the tangential direction of the molding drum and is separated from the rubber member upon start of the rotation of the molding drum.

8. The method for manufacturing a green tire according to claim 6,
wherein the rubber member is wound onto the molding drum so that a part of the rubber member is to overlap an annular rubber member wound on the molding drum in an axial direction of the molding drum.

9. The apparatus for manufacturing a green tire according to claim 2,
wherein the pressing member is configured to move in the tangential direction of the molding drum upon start of the rotation of the molding drum.

10. The apparatus for manufacturing a green tire according to claim 2,
wherein the pressing member is a roller.

11. The apparatus for manufacturing a green tire according to claim 3,
wherein the pressing member is a roller.

12. The method for manufacturing a green tire according to claim 7,
wherein the rubber member is wound onto the molding drum so that a part of the rubber member is to overlap an annular rubber member wound on the molding drum in an axial direction of the molding drum.
